(19) United States
(12) Patent Application Publication
(10) Pub. No.: US 2018/0122005 A1
(43) Pub. Date: May 3, 2018

(54) SYSTEMS AND METHODS FOR APPLYING SENSOR ANALYSIS TO FINANCIAL UNDERWRITING

(71) Applicant: Capital One Financial Corporation, McLean, VA (US)

(72) Inventors: Luke A. Hammock, Washington, DC (US); Lawrence H. Douglas, Mclean, VA (US)

(73) Assignee: Capital One Financial Corporation, McLean, VA (US)

(21) Appl. No.: 15/855,916

(22) Filed: Dec. 27, 2017

Related U.S. Application Data
(63) Continuation of application No. 14/595,962, filed on Jan. 13, 2015.
(60) Provisional application No. 61/927,205, filed on Jan. 14, 2014.

(51) Int. Cl. G06Q 40/02

(52) U.S. Cl. CPC G06Q 40/025

(57) ABSTRACT

Systems and methods are disclosed for determining the value of secured assets associated with loan accounts. In one implementation, a financial service system configures a secured loan account for a customer. The system determines an asset belonging to the customer to serve as the secured collateral for the loan. One or more sensors are configured to monitor information associated with the asset. The financial service system may periodically sample the sensor information associated with the asset, and use the sensor information to determine a present valuation of the secured asset. The sensor information may also be used to modify the loan terms, or to generate advertising targeted to the customer for related goods or services.

### CROSS-REFERENCE TO RELATED APPLICATIONS

This application claims priority under 35 U.S.C. § 119 to U.S. Provisional Application No. 61/927,205, filed Jan. 14, 2014, which is expressly incorporated herein by reference in its entirety.

### FIELD

The disclosed embodiments relate to the underwriting of secured financial loan products and, in particular, to improving the appraisal process for the value of goods by using sensors.

### BACKGROUND

Secured loans are commonplace in modern financial systems. A secured loan may be deemed suitable for a particular loan or a particular customer for a number of reasons, such as the customer's creditworthiness or the size of the principal. Typically, an asset belonging to the customer is secured as part of the loan process to serve as collateral should the customer default on the loan. In those instances, the financial institution assumes ownership of the secured item and may, for example, sell it to help pay off the loan principal with the proceeds.

Today, valuation of secured assets is a somewhat inexact science. Determining a proper value for an asset that is to be secured largely depends on the experience and skill of a human appraiser. For example, an experienced home appraiser may be trained to judge a home's value based on local market sales comparisons and conditions within the home. This valuation can be supplemented by the financial institution with information such as customer creditworthiness, income, payment history, etc. For chattel such as automobiles, the valuation may simply be based on a rote comparison with cars of similar make, model, and mileage. Sometimes these valuations are accurate, but no human analyst is perfect. Further, there is always the potential for fraud and deceit, and the customer may also endanger the value of the item through their own actions. For example, a car may be “worth” more in the hands of a safe driver rather than a reckless driver. There are serious consequences if a financial institution makes a mistake in the asset valuation—it can lead to a forfeit of a portion or the entirety of the loan principal on default when the secured asset turns out to be worth less than expected.

Accordingly, there is a need to provide financial institutions with enhanced valuation techniques for secured assets that serve as loan collateral.

### SUMMARY

Methods, systems, and articles of manufacture described herein enable a computer system to determine the value of a secured asset associated with a loan account. In one embodiment, a computing system may configure a secured loan account according to a plurality of terms for a customer. The computing system may further determine an asset to serve as collateral for the secured loan account. Also, the computing system may configure one or ore sensors associated with the asset. The computing system may additionally determine information to acquire from the configured one or more sensors, and may acquire the determined information from the configured one or more sensors. Further, the computing system may determine a present value of the asset based at least on the acquired information.

In another embodiment, a method for determining the value of a secured asset associated with a loan account is disclosed. The method includes configuring a secured loan account according to a plurality of terms for a customer. Additionally, the method comprises determining an asset to serve as collateral for the secured loan account. The method further comprises configuring one or more sensors associated with the asset. The method also includes determining information to acquire from the configured one or more sensors, and acquiring the determined information from the configured one or more sensors. Further, the method comprises determining a present value of the asset based at least on the acquired information.

In still another embodiment, a computing system for providing targeted advertising to a consumer is disclosed. The computing system may determine an object belonging to the consumer associated with one or more open sensors. The computing system may further configure access to the one or more open sensors associated with the object. Also, the computing system may determine information to acquire from the one or more open sensors. The computing system may additionally acquire the determined information from the configured one or more sensors. Further, the computing system may determine at least one incentive offer to provide the consumer based on at least the acquired information, and provide the at least one incentive offer to the consumer.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIG. 2 is a flowchart of an exemplary asset valuation process consistent with disclosed embodiments;

FIG. 3 is a flowchart of an exemplary sensory configuration process consistent with disclosed embodiments;

FIG. 4 is a flowchart of an exemplary sensor data sampling process consistent with disclosed embodiments;

FIG. 5 is a flowchart of an exemplary loan modification process consistent with disclosed embodiments;

FIG. 6 is a flowchart of an exemplary sensor service notification process consistent with disclosed embodiments; and

FIG. 7 is a flowchart of an exemplary targeted marketing process consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, disclosed embodiments are directed to systems and methods for determining the value of secured assets associated with loan accounts. For ease of discussion, embodiments may be described in connection with the sale of real estate, especially homes, and mortgage loans commonly used to finance their purchase. Embodiments may also be described in connection with the sale of new or used automobiles, and loans used to finance their purchase. It is to be understood, however, that disclosed embodiments are not limited to the sale of real estate or automobiles and may, in fact, be applied to financing the sale, auctioning, renting, etc. of any item, product, or service. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

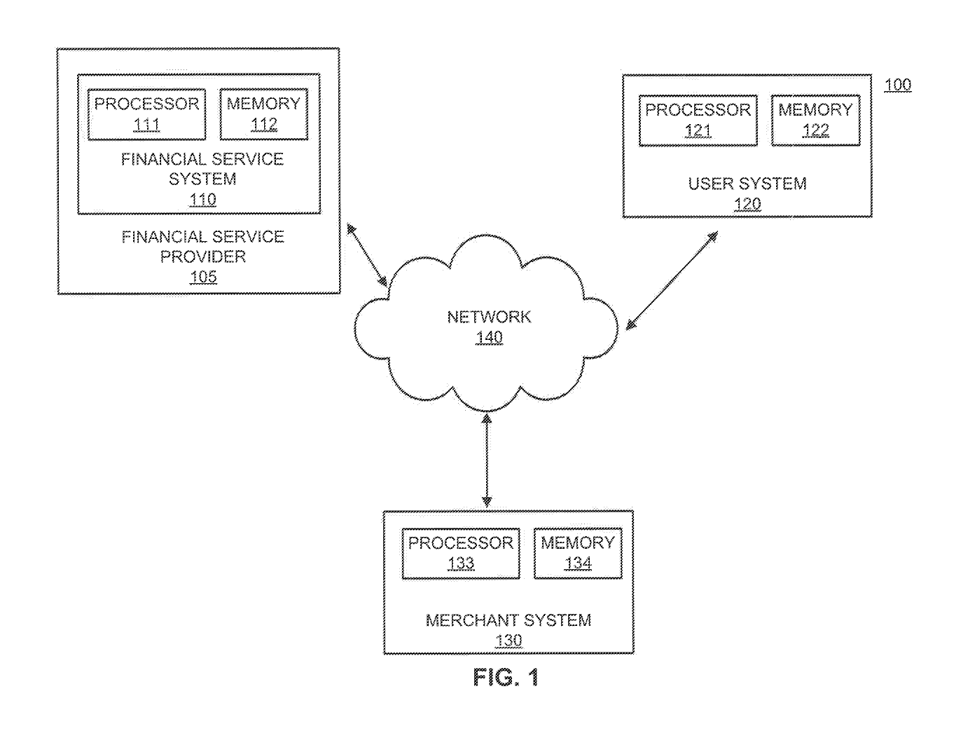

FIG. 1 illustrates an exemplary system 100 consistent with disclosed embodiments. In one aspect, system 100 may include a financial service provider 105, a user system 120, a merchant system 130, and a network 140.

Financial service provider 105 may be one or more entities that configure, offer, provide, and/or manage financial service accounts, such as credit card accounts, debit card accounts, checking or savings accounts, loyalty accounts, and/or loan accounts. In one aspect, financial service provider 105 may include or be associated with a financial service system 110 that may be configured to perform one or more aspects of the disclosed embodiments. In some embodiments, financial service system 110 may configure one or more loan accounts for a customer of financial service provider 105. In these embodiments the customer may be a user operating user system 120, using information pertaining to one or more additional financial service accounts provided by financial service provider 105 associated with financial service system 110.

Financial service system 110 may be a system associated with one or more entities that configure, offer, provide, and/or manage financial service accounts, such as credit card accounts, debit card accounts, checking or savings accounts, and loan accounts. Consistent with the disclosure, financial service system 110 may provide a loan account for financing a purchase to one or more users operating user system 120. In some embodiments, the loan account may be a mortgage loan account. In some embodiments, financial service system 110 may receive and process payments from customers (via, e.g., user system 120) relating to provided financial service accounts. In some embodiments, financial service system 110 may be configured to transmit financial information, such as that related to financial service accounts, creditworthiness, etc. related to one or more users operating user system 120, to one or more merchant systems 130 to provide the user a more informed shopping and research experience in preparation for a purchase. Financial service system 110 may be configured to assess the creditworthiness and risk presented by a prospective buyer of an item or service in real-time or substantially real-time, and to offer different financing packages depending on those assessments.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts, maintaining accounts, processing information relating to accounts, etc. Consistent with disclosed embodiments, financial service system 110 may include other components and infrastructure that enable it to perform operations, processes, and services consistent with financial service account providers, such as banking operations, credit card operations, loan operations, etc. Consistent with disclosed embodiments, financial service system 110 may be configured to provide, manage, monitor, and assess a prospective financing program for a purchase transaction involving user system 120 and/or merchant system 130.

User system 120 may represent a system associated with an entity seeking to buy an item from another party. Although the following description of disclosed embodiments may refer to an “individual,” it is to be understood that the same description applies to multiple users acting in concert or to a user entity in the manner described above. As discussed above, user system 120 may be associated with a customer of financial service provider 105. User system 120 may include one or more components that perform processes consistent with the disclosed embodiments. For example, user system 120 may include one or more computers (e.g., servers, database systems, etc.) that are configured to execute software instructions programmed to perform aspects of the disclosed embodiments. One of ordinary skill in the art would recognize that user system 120 may include components and infrastructure that enable it to perform operations, processes, and services such as processing sales transactions of purchases made over the Internet or at POS locations, and communicating with financial service system 110, merchant system 130, or other components relating to the transactions. User system 120 may be configured to purchase an item, transmit and receive information associated with the purchase transaction, and process and monitor a loan account associated with financing the purchase transaction.

Merchant system 130 may represent one or more entities that provide goods and/or services that may be purchased by consumers, such as the user operating user system 120. For example, merchant system 130 may represent a vendor that offers goods or services that the user operating user system 120 purchases using one or more of the financial service accounts held by the user and provided by financial service system 110 or merchant system 130. Merchant system 130 may offer goods and services directly over normal channels of trade (i.e., a point of sale (POS) purchase), or they may offer them over network 140 (i.e. telephonically or “online” via the Internet).

Merchant system 130 may include one or more components that perform processes consistent with the disclosed embodiments. For example, merchant system 130 may include one or more computers (e.g., servers, database systems, etc.) that are configured to execute software instructions programmed to perform aspects of the disclosed embodiments. One of ordinary skill in the art would recognize that merchant system 130 may include components and infrastructure that enable it to perform operations, processes, and services consistent with merchants, such as providing websites that offer for sale goods and/or services, processing sales transactions of purchases made over the Internet or at POS locations, and communicating with financial service system 110 or other components relating to the transactions. Consistent with disclosed embodiments, buyer system 130 may be configured to market or sell an item or service, transmit and receive information associated with the purchase transaction, and process and monitor a loan account associated with financing the purchase transaction.

Consistent with disclosed embodiments, components of system 100, including financial service system 110, user system 120, and merchant system 130, may include one or more processors (such as processors 111, 121, or 131) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial service system 110, user system 120, and/or merchant system 130 to execute multiple processes simultaneously. Other types of processor arrangements could be implemented that provide for the capabilities disclosed herein. Moreover, the processors may represent one or more servers or other computing devices that are associated with financial service system 110, user system 120, and/or merchant system 130. For instance, the processors may represent a distributed network of processors configured to operate together over a local or wide area network. Alternatively, the processors may be a processing device configured to execute software instructions that receive and send information, instructions, etc. to/from other processing devices associated with financial service system 110 or other components of system 100. In certain aspects, processors 111, 121, and/or 131 may be configured to execute software instructions stored in memory to perform one or more processes consistent with disclosed embodiments.

Consistent with disclosed embodiments, components of system 100, including financial service system 110, user system 120, and merchant system 130, may also include one or more memory devices (such as memories 112, 122, and 132) as shown in exemplary form in FIG. 1. The memory devices may store software instructions that are executed by processors 111, 121, and/or 131, such as instructions associated with one or more applications, network communication processes, operating system software, software instructions relating to the disclosed embodiments, and any other type of application or software known to be executable by processing devices. The memory devices may be volatile or non-volatile, magnetic, semiconductor, tape, optical, removable, nonremovable, or other types of storage devices or tangible computer-readable media. The memory devices may be two or more memory devices distributed over a local or wide area network, or may be a single memory device. In disclosed embodiments, the memory devices may include database systems, such as database storage devices, configured to receive instructions to access, process, and send information stored in the storage devices.

In some embodiments, financial service system 110, user system 120, and merchant system 130 may also include one or more additional components (not shown) that provide communications with other components of system environment 100, such as through network 140, or any other suitable communications infrastructure.

Network 140 may be any type of network that facilitates communications and data transfer between components of system environment 100, such as, for example, financial service system 110, user system 120, and merchant system 130. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may use cloud computing technologies.

Moreover, any part of network 140 may be implemented through infrastructures or channels of trade to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system 100, any number or combination of components may be implemented without departing from the scope of the disclosed embodiments. For example, different user systems 120 may interact with one or more merchant systems 130 through network 140 or standard channels of trade, such as face-to-face purchase transactions. In another example, different financial service systems 110 may interact with one or more user systems 120 and merchant systems 130 through network 140 or standard channels of trade. Additionally, financial service system 110, user system 120, and merchant system 130 are not mutually exclusive For example, in one embodiment, financial service system 110 and merchant system 130 may be the same entity. In another embodiment, user system 120 and merchant system 130 may be the same entity. Thus, the entities as described are not limited to their discrete descriptions above. Further, where different components of system environment 100 are combined (e.g., financial service system 110 and merchant system 130, etc.), the computing and processing devices and software executed by these components may be integrated into a local or distributed system.

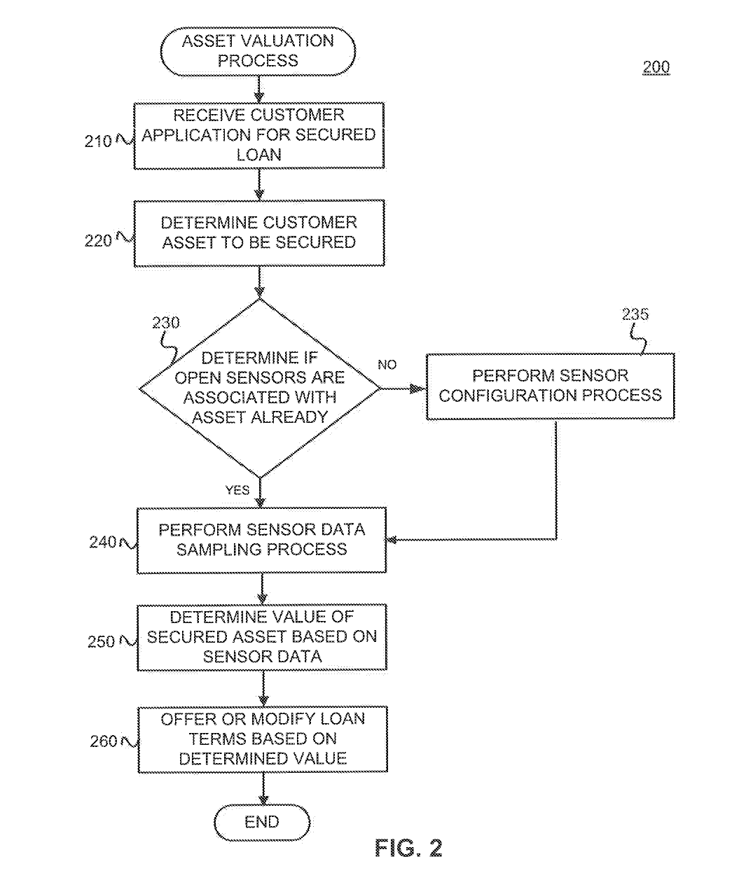

FIG. 2 illustrates an exemplary asset valuation process 200 consistent with disclosed embodiments. Asset valuation process 200, as well as any or all of the individual steps therein, may be performed by any one or more of financial service system 110, user system 120, or merchant system 130. For exemplary purposes, FIG. 2 is disclosed as being performed by financial service system 110.

Financial service system 110 may receive a customer application for a secured loan (Step 210). For exemplary purposes, the customer may be associated with user system 120. In some embodiments, financial service system 110 may receive the application through a website or other Internet portal via network 140 set up for such a purpose. In other embodiments, financial service system 110 may receive the application via a mobile application. In other embodiments, financial service system 110 may receive the application via an electronic message. In still other embodiments, financial system 110 may receive the application via a brick and mortar location associated with financial service provider 105. It is understood that these examples are not intended to be limiting, and that financial service system 110 may receive the application from user system 120 via any number of methods of communication.

Financial service system 110 may determine an asset associated with the loan customer to be secured as collateral for the loan (Step 220). In some embodiments, the loan customer may propose an asset to serve as collateral, and may transmit information regarding the asset to financial service system 110 via user system 120. In other embodiments, financial service system 110 may receive a list comprising one or more possible assets to be secured, and may select one or more of the assets based on preliminary and/or past valuations. In still other embodiments, financial service system 110 may propose the asset to be secured. In some embodiments, the principal amount of the loan may determine the asset to be secured.

In some embodiments, financial service system 110 may determine whether one or more sensors are already associated with the asset (Step 230). Consistent with disclosed embodiments, the one or more sensors may constitute “open” sensors. As used herein, an “open” sensor is a sensor that may be configured by any entity for access by one or more other entities. For example, the loan customer associated with user system 120 may purchase an automobile from merchant system 130. Prior to transferring the car to the customer, merchant system 130 may install and configure an open sensor in the car's central computer. This sensor may be configured to transmit information to merchant system 130 and other external computing systems that may or may not be associated with merchant system 130. For example, merchant system 130 may provide access to open sensor data associated with the consumer's car to a local mechanic for maintenance purposes. In other embodiments, merchant system 130 might provide access to open sensor data to a financial service system (such as system 110) associated with a financing provider (such as financial service provider 105) for purposes relating to financing or valuation consistent with disclosed embodiments. In alternative embodiments, a sensor may not necessarily be truly “open” and financial service system 110 may access the data through an intermediary, such as merchant system 130.

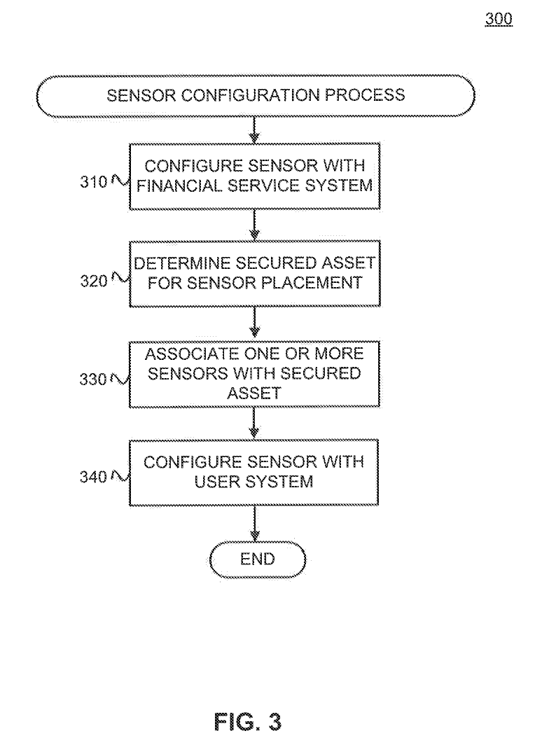

If no sensors (open or otherwise) are associated with the asset to be secured (Step 230: NO); financial service system 110 may perform a sensor configuration process (Step 235). An example sensor configuration process will be described in detail below in association with FIG. 3. In brief, financial service system 110 may configure one or more sensors to communicate with components of its system. Financial service system 110 may determine the secured asset to be associated with the one or more sensors, and may associate the one or more sensors with the asset. Finally, financial service system 110 may configure the one or more sensors to operate or interface with user system 120, to provide information to the customer, or to provide communication capabilities for interfacing with system 110 or other external systems.

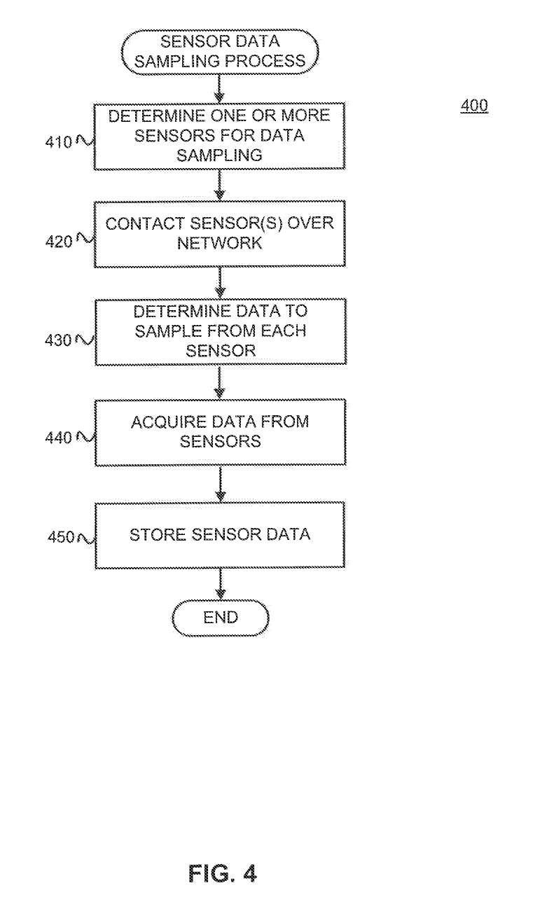

If there are sensors associated with the asset already (Step 230: YES), or if financial service system 110 completes a sensor configuration process via Step 235, financial service system 110 may perform a sensor data sampling process (Step 240). An example sensor data sampling process will be described in detail below in association with FIG. 4. In brief, financial service system 110 may determine one or more sensors associated with one or more secured assets for sampling of sensor data. Financial service system 110, via network 140, may contact the chosen sensors, determine the data to sample from each sensor, and acquire the data. Financial service system 110 may then store the sampled data for analysis (for example, in memory 112).

Underwriters associated with financial service system 110 may determine a present value of the secured asset based on the sampled sensor data (Step 250). In some embodiments, financial service system 110 may analyze the sensor data to determine information about the status of the asset, such as its age, condition, operating status, future needs for service, etc. It is understood that these are intended as non-limiting examples, and financial service system 110 may determine any information relevant to valuation from the sensor data. In some embodiments, financial service system 110 may compare information obtained via analysis of the sensor data to pre-existing or pre-determined criteria relating to the particular asset. For example, in embodiments where the secured asset is an automobile, underwriters associated with financial service system 110 may compare information about the car to an existing source of valuation information, such as the Kelley BlueBook™. In other embodiments, other valuation systems or criteria may be used depending on the asset. For example, in embodiments where the secured asset is a home, financial service system 110 may compare the sensor information associated with the home and/or surrounding land to databases like an MLS® database.

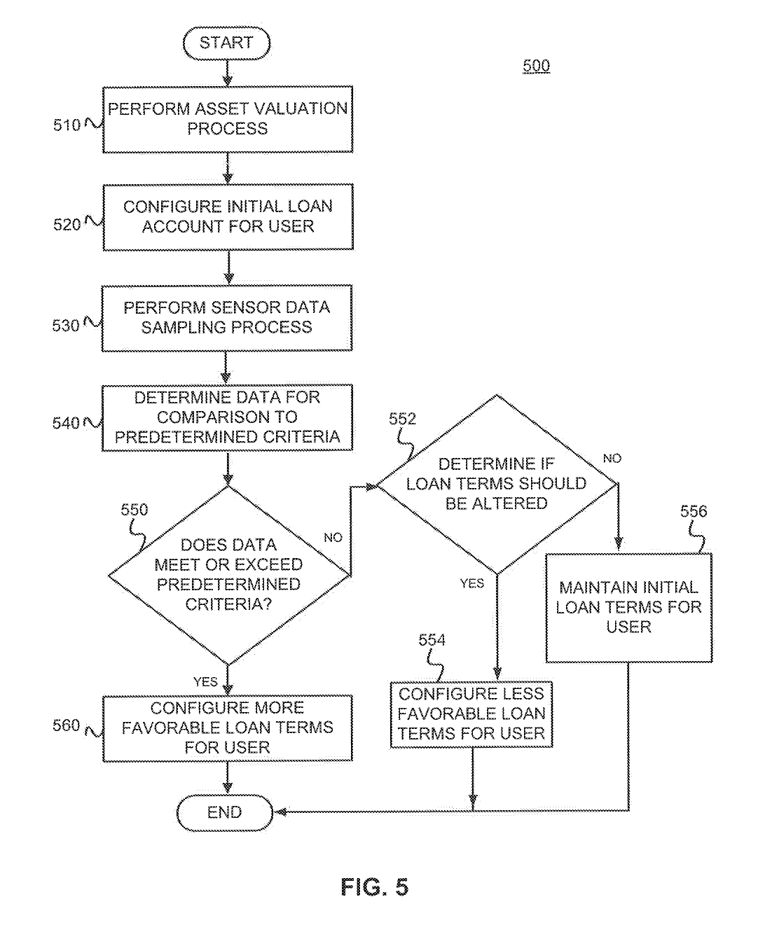

In some embodiments, financial service system 110 may offer initial loan terms or modify existing loan terms based on the determined present valuation of the secured asset (Step 260). An example of such a loan modification process for an existing secured loan is described below in association with FIG. 5. In brief, underwriters associated with financial service system 110 may determine whether information or data obtained from sensors associated with the secured asset meets or exceeds predetermined valuation criteria for that class of asset. If the sensor data indicates that the asset does meet or exceed the criteria (i.e., the asset is actually worth more than it initially appeared), financial service system 110 may configure more favorable loan terms for the loan customer associated with user system 120. Alternatively, if the sensor data indicates that the asset does not meet or exceed the valuation criteria (i.e., the asset is worth less than it initially appeared), financial service system 110 may determine to either maintain the existing loan terms, or configure less favorable loan terms for the customer.

FIG. 3 illustrates an exemplary sensor configuration process 300, consistent with disclosed embodiments. Sensor configuration process 300, as well as any or all of the individual steps therein, may be performed by any one or more of financial service system 110, user system 120, and merchant system 130. For exemplary purposes, FIG. 3 is disclosed as being performed by financial service system 110.

Financial service system 110 may configure one or more sensors to communicate with the system via a network, such as network 140 (Step 310). In some embodiments, financial service system 110 may configure the types of data that will be monitored by the sensors. The information may vary based on the secured asset or other item that will be associated with the sensor. Financial service system may determine the secured asset owned by the loan applicant (Step 320) and may subsequently determine what information could and/or should be monitored in association with ongoing valuation of that asset.

For example, in some embodiments, one or more sensors may be associated with real estate, such as a home, that will serve as the secured asset. In current systems, a financial service system must rely on observations of human appraisers to determine a valuation of the home and the property. In disclosed embodiments, various sensors may be configured to sample data related to various systems or fixtures of the home. These systems may include, but not be limited to, a furnace, an air conditioning system, a heat pump, a water heater, one or more appliances, sump pumps, etc. Specific sensors may also be installed within the home to detect events, scenarios, or matter, such as water sensors, smoke sensors, fire sensors, carbon monoxide sensors, radon sensors, etc. In some embodiments, these sensors may enable financial service system 110 to assess information about the house including, but not limited to, the age of equipment in the house, the operating performance of equipment in the house, the presence of one or more error codes that may indicate past, current, or future problems with systems within the home, information relating to maintenance history of various systems and components, information relating to operation of the system (for example, information showing that a sump pump was operated for eight consecutive hours, suggesting flooding), occurrence of events (for example, trigger of a water sensor above a certain height level), stress or strain in beams, foundations, or other structural elements of the house, ambient conditions of the home interior such as temperature, humidity, etc., triggering of dangers (for example, radon or carbon monoxide situations), status of a security system or evidence of a security breach, or maintenance/operating status of the sensor itself. In some embodiments, the sensor may comprise a camera, which may visually monitor the exterior or interior of the home. In these embodiments, the sensor may be configured to provide feedback to an external system, such as financial service system 110 or user system 120, when certain triggering events such as those described above occur.

In other embodiments, the secured asset may be an automobile. In disclosed embodiments, various sensors may be configured to sample data related to various systems or features of the automobile. For example, financial service system 110 may configure sensors to detect the driving style of the customer associated with the car. Financial service system 110 may use such data to correlate driving style with likelihood of a damage or loss claim. Underwriters may further use this information to determine the risk level of a loan to the customer. Specific sensors may also be installed within the automobile to detect specific events, scenarios, or matter that could impact its valuation, such as VIN number (indicating make, model, age, repair history, registration history, and/or violation history), overall mileage driven (and/or consistency with the odometer), mileage driven by this particular customer (and perhaps when the mileage occurs, i.e. weekday versus weekend), G forces experienced (indicating hard stops, which suggest risky behavior), rate of acceleration and braking, evidence of speeds driven above or below the posted speed limit (perhaps integrated with a GPS system to determine speed limits), presence of passengers in the car (via weight sensors in seats), operating performance of systems (such as air conditioning, heat, engine, brakes, etc.), presence of error codes indicating a past, current, or future need for maintenance, maintenance history, status of a security system or evidence of a security breach, or maintenance/operating status of the sensor itself. These are intended only as examples; a skilled artisan may determine any information that may be gathered by sensor from any type of secured asset.

After determining the secured asset and the information to monitor via one or more sensors, financial service system 110 may associate the one or more sensors with the secured asset (Step 330). The manner of association may vary based on the circumstances of the loan and the secured asset itself. For example, in embodiments where the secured asset is an automobile, a sensor may be configured to communicate with the automobile's central computer. Financial service system 110 may provide the sensor(s) to the consumer associated with user system 120 themselves as a condition of the loan for association with the secured asset. In other embodiments, an agent associated with financial service system 110 may install the one or more sensors. In still other embodiments, a third party may install the sensor(s), such as a mechanic or a home appraiser. In some embodiments, the one or more sensors may be pre-installed in computing systems associated with the secured asset. After associating the sensor with the secured asset, financial service system 110 may configure the sensor to communicate and/or interface with user system 120 (Step 340). For example, the one or more sensors may be configured to use communication elements of user system 120 to transmit information relating to the secured asset (as described above) to financial service system 110.

FIG. 4 illustrates an exemplary sensor data sampling process 400, consistent with disclosed embodiments. Sensor data sampling process 400, as well as any or all of the individual steps therein, may be performed by any one or more of financial service system 110, user system 120, and merchant system 130. For exemplary purposes, FIG. 4 is disclosed as being performed by financial service system 110.

Financial service system 110 may determine one or more sensors for data sampling (Step 410). In some embodiments, financial service system 110 may determine that data sampling is required from a particular sensor, such as a sensor associated with a particular user system 120 or a particular secured asset. In other embodiments, financial service system may choose to sample a wider collection of sensors, such as sensors associated with several or all secured loan customers.

Financial service system 110 may contact the one or more determined sensors over network 140 (Step 420). The method of contact may depend on the previous configuration performed for the sensor(s) by financial service system 110. For example, the sensor may be configured to communicate data directly to financial service system 110. In other embodiments, the sensor may be configured to communicate data to financial service system 110 via user system 120. In still other embodiments, the sensor may be configured to communicate data to a third party (for example, merchant system 130), and financial service system 110 may receive the data from the third party.

Financial service system 110 may determine the data to sample from each sensor (Step 430). As discussed above, in association with sensor configuration process 300, financial service system 110 may sample different data based on the nature of the secured asset. For example, if the secured asset is an automobile, financial service system 110 may determine to sample data relating to mileage driven, collision status, or data relating to rate of deceleration and acceleration that may indicate risky driving habits. In embodiments where the secured asset is a home, financial service system 110 may determine to sample data relating to various environmental factors (water, smoke, radon, etc.), the condition of the foundation or structural beams, or information relating to how many people are living in the house. Once the data to be sampled from each sensor is determined, financial service system 110 may acquire the determined data from the sensors (Step 440). At step 450, financial service system 110 may further store the data within internal storage, such as memory 112 or an associated database (not shown).

FIG. 5 illustrates an exemplary loan modification process 500, consistent with disclosed embodiments. Loan modification process 500, as well as any or all of the individual steps therein, may be performed by any one or more of financial service system 110, user system 120, and merchant system 130. For exemplary purposes, FIG. 5 is disclosed as being performed by financial service system 110.

Financial service system 110 may begin the loan modification process by performing an asset valuation process to determine the value of an asset serving as collateral for a secured loan (Step 510). The asset valuation process may be substantially the same as that described above in association with FIG. 2, and may incorporate data from sensors to determine a more accurate valuation of the asset. In other embodiments, the asset valuation process may be a different process than that described in FIG. 2, and may be a traditional manual valuation performed by a human appraiser associated with financial service system 110. After determining an initial valuation of the securable asset, financial service system 110 may configure an initial loan account for the loan customer (Step 520). In some embodiments, financial service system 110 may determine various terms of the loan at the onset of the financing process, such as the principal of the loan, the interest rate of the loan, and a repayment schedule for the loan.

Financial service system 110 may perform a sensor data sampling process to monitor the value of the secured asset on an ongoing basis (Step 530). The sensor data sampling process may be substantially the same process as that discussed above in association with FIG. 4. In some embodiments, financial service system 110 may perform the sensor data sampling process at regular intervals, such as daily, weekly, monthly, quarterly, semi-annually, annually, or biannually. In other embodiments, financial service system 110 may perform the sensor data sampling process on demand, for example, at the request of the loan customer associated with user system 120, at the request of an individual associated with financial service provider 105, or at the request of a third party, such as merchant system 130.

Financial service system 110 may determine some or all of the sensor data to compare to pre-existing or predetermined criteria associated with the particular secured asset (Step 540). As discussed above, financial service system 110 may consider any information derived from sensor data in making a valuation comparison of the asset, such as information relating to age, condition, maintenance status, damage, improvements, etc. It is understood that these are non-limiting examples and that any information received from a sensor that may raise or lower the valuation of the asset may be considered for evaluation and comparison.

Financial service system 110 may determine whether the selected data meets or exceeds predetermined valuation criteria for the secured asset (Step 550). As discussed above, the predetermined criteria may comprise industry standards for the asset, such as the Kelley BlueBook™ for automobiles. The predetermined criteria may also comprise internal standards set forth by financial service provider 105. Any criteria may be used as a comparison benchmark, including average values derived from other sensor data taken from assets of other customers of financial service provider 105.

If the selected data is determined to not meet or exceed the predetermined valuation criteria benchmark(s) (Step 550: NO), then financial service system 110 may determine if the loan terms, such as the interest rate or the repayment schedule, should be altered (Step 552). If, for example, the sampling of the sensor data associated with the secured asset demonstrates that the value of the asset has substantially decreased unexpectedly, or is substantially lower than the initial valuation for any reason, financial service system 110 may determine that the loan terms should be altered (Step 552: YES). In these embodiments, financial service system 110 may configure less favorable loan terms for the user (Step 554), such as a higher interest rate, points on the loan, faster repayment, etc., including possibly calling in the loan or seizing the secured asset plus additional fees. The negative loan term modification may be temporary, and financial service system 110 may revisit the modification at a later time by repeating process 500. Alternatively, financial service system 110 may determine that loan terms should not be altered (Step 552: NO), and may maintain the initial loan terms for the user (Step 556). Financial service system 110 may opt to transmit a notification to user system 120 indicating a decision on loan modification. This notification may further inform the customer, for example, that further devaluation of the asset may result in negative loan modification.

In other embodiments, financial service system 110 may determine from sensor data and comparison with predetermined criteria that the secured asset has actually increased in value, or is worth more in any respect than the initial valuation (Step 550: YES). In these embodiments, financial service system may configure more favorable loan terms for the loan customer (Step 560). For example, financial service system 110 may lower the interest rate of the loan, may forgive a portion of the principal, may refinance the loan, may convert the loan terms from a variable interest rate to a fixed interest rate, may convert the loan from a secured loan to an unsecured loan (and release the collateral), may configure a more favorable repayment schedule, or any other favorable loan modification from the perspective of the user. As discussed above, financial service system 110 may be configured to periodically revisit the loan modification, and should the asset decrease in value later based on sensor data, financial service system 110 may reserve the right to revert the loan terms back to the initial terms or to other less favorable terms.

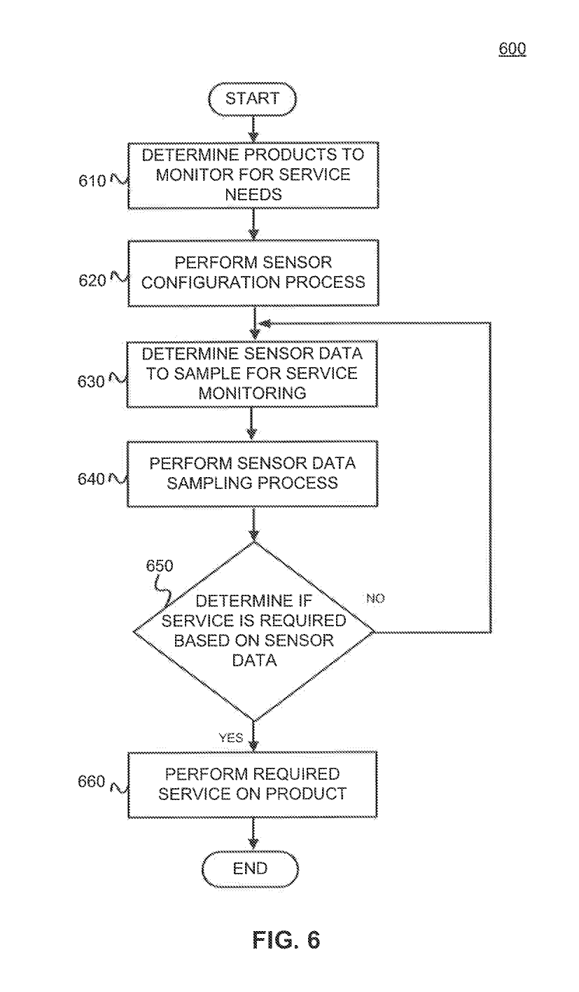

Beyond underwriting and loan applications, the disclosed embodiments may also be adapted for a variety of alternative purposes, which will now be described in detail. For example, sensor data may be used to assist a service provider and an owner of a product or asset with regular service and maintenance of the asset. FIG. 6 illustrates an exemplary sensor service notification process 600, consistent with disclosed embodiments. Sensor data sampling process 400, as well as any or all of the individual steps therein, may be performed by any one or more of financial service system 110, user system 120, and merchant system 130. For exemplary purposes, FIG. 6 is disclosed as being performed by merchant system 130.

Merchant system 130 may determine one or more products or assets to monitor for service needs (Step 610). In some embodiments, the product may have been sold to the customer by merchant system 130, or by a related entity. The sensor-based service monitoring may be configured as a standard feature associated with the product/asset, or it may be an added service contracted for by user system 120 and merchant system 130.

Merchant system 130 may perform a sensor configuration process (Step 620). In some embodiments, the sensor configuration process may be substantially the same as that described above in association with FIG. 3. In other embodiments, the configuration may be different. For example, a given product may be configured to come from the factory with sensors pre-installed and pre-configured, and merchant system 130 may need no further configuration to begin service monitoring.

Merchant system 130 may determine the sensor data to sample for the purposes of the service monitoring (Step 630). The sensor data to sample may vary based on a given user system 120, a given merchant system 130, or a given product. For example, in one embodiment, merchant system 130 may be associated with a heating and cooling provider, and the product/asset to be monitored is an air conditioner. In this embodiment, merchant system 130 may opt to sample sensor data relating to the operation and function of the air conditioning system, such as the last time the system was serviced, the level of coolant, the age of the system, or the number of hours the system has been operated over a particular period of time. It is understood that these are non-limiting examples, and that merchant system 130 may sample any data configured to be monitored by a sensor.

Merchant system 130 may perform a sensor data sampling process (Step 640). The sensor data sampling process may be substantially the same as that described above in association with FIG. 4. In brief, merchant system 130 may contact the sensor for the selected product via a network (such as network 140), acquire the desired data, and store the data (for example, in memory 132).

Based on the sampled sensor data, merchant system 130 may determine if service or maintenance is required on the product or asset (Step 650). If nothing in the sensor data indicates a problem with the product (Step 650: NO), merchant system 130 may choose not to perform service/maintenance on the product at that time, and may repeat Steps 630-650 at a later time (i.e. daily, weekly, monthly, etc.) to continue to monitor the status of the product. Alternatively, merchant system 130 may determine from the sampled sensor data that service is required on the product (Step 650: YES). For example, in some embodiments, the sensor may be configured to transmit one or more error codes indicating a specific need for service or maintenance. In other embodiments, no error code(s) may be transmitted, but merchant system 130 may determine that service is needed based on comparison of the sensor data with predetermined criteria for the particular product. For example, an air conditioner that has not had its air filter replaced in over twelve months may necessitate service. Should merchant system 130 determine that service is necessary, an agent associated with merchant system 130 may perform the required service on the product (Step 660). Alternatively, merchant system 130, the sensor, and/or the product may be configured in a manner such that the service may be performed remotely over network 140.

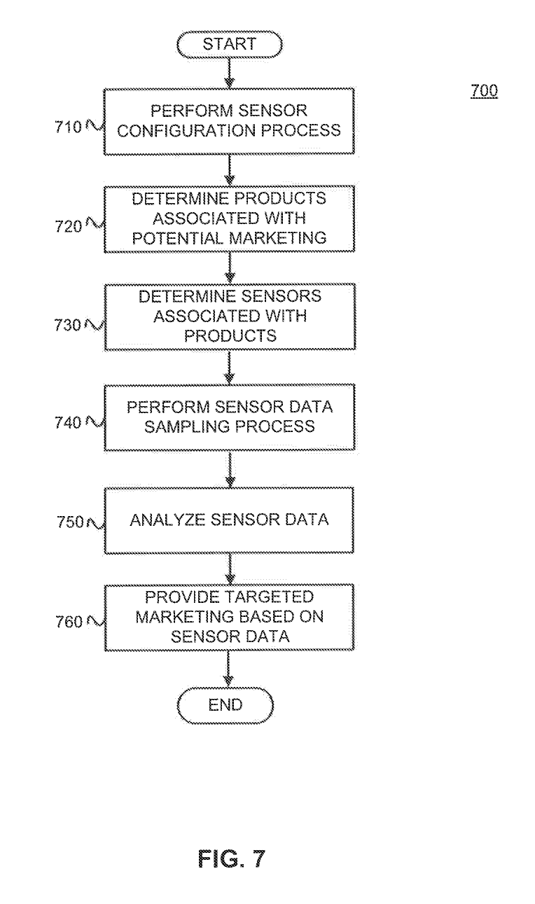

Another potential application of the disclosed embodiments is in the field of advertising and marketing. FIG. 7 illustrates an exemplary targeted marketing process 700, consistent with disclosed embodiments. Targeted marketing process 700, as well as any or all of the individual steps therein, may be performed by any one or more of financial service system 110, user system 120, and merchant system 130. For exemplary purposes, FIG. 6 is disclosed as being performed by merchant system 130.

Merchant system 130, via processor 131, may perform a sensor configuration process (Step 710). In some embodiments, the sensor configuration process may be substantially the same as the process described above in association with FIG. 3. In some embodiments, merchant system 130 may be assisted in the performance of the sensor configuration process by financial service system 110 and/or user system 120. In brief, in some embodiments, merchant system 130 may configure one or more sensors with a computer system, such as financial service system 110, user system 120, or its own associated computer system, and may determine one or more products or assets associated with consumers to associate with the one or more sensors. Alternatively, in other embodiments, merchant system 130 may gain access to one or more sensors previously configured by another entity.

Merchant system 130 may determine one or more products or assets associated with one or more consumers associated with potential marketing efforts (Step 720). In some embodiments, the marketing efforts may comprise incentive offers, coupons, or other advertising for various goods and/or services. In some embodiments, the potential marketing may be directed towards goods and/or services that are associated with configured open sensors such as those described above. As an example, merchant system 130 may seek to target incentive offers or other advertising associated with cooling system maintenance services to consumers who own air conditioning systems configured with open sensors just before the onset of a heat wave. In other embodiments, merchant system 130 may seek to provide consumers, such as a consumer associated with user system 120, with targeted advertising for goods and/or services other than those associated with sensors. In these embodiments, merchant system 130 may use the sensor data to generate the targeted advertising.

Merchant system 130 may determine particular sensors associated with the determined products for targeted advertising (Step 730). As discussed above, in some embodiments, merchant system 130 may determine to sample data from sensors that merchant system 130 itself configured. In other embodiments, merchant system 130 may determine sensors on the targeted products or associated with a subset of targeted consumers that were previously configured by another entity. In some embodiments, the sensors determined by merchant system 130 may be open sensors. In these embodiments, merchant system 130 may take steps necessary to gain access to the open sensor data. For example, merchant system 130 may connect to a network (such as network 140) that may enable sampling of open sensor data by a plurality of users. In other embodiments, merchant system 130 may configure an account or profile on an external system to gain access to existing open sensors.

Merchant system 130 may perform a sensor data sampling process (Step 740). In some embodiments, the process may be substantially the same as the sensor data sampling process described above in association with FIG. 4. In brief, merchant system 130 may determine particular sensors to sample data from, and may establish contact with those sensors over a network, such as network 140. Merchant system 130 may determine data to sample from each of the particular sensors. For example, in the air conditioning example described above, merchant system 130 may seek to sample data from sensor-equipped customer systems such as age of the system, date of last maintenance, level of coolant in the system, average ambient temperature surrounding the system, etc. Merchant system 130 may then acquire the desired data from the sensors, and store the data in an associated memory, such as memory 132. In alternative embodiments, merchant system 130 may access a secondary report of the data sampling gathered by another party, such as financial service system 110.

Merchant system 130 may analyze the data sampled from the one or more particular open sensors (Step 750). Data analysis may include various mapping, correlating, calculating, summarizing, or other such steps to gather particular insight from the sampled data. In some embodiments, analyzing the data may include separating the data into two or more groupings based on information sampled from the sensors. In these embodiments, the groupings may be further sorted using other outside information, such as demographic information of the customer (age, financial status, etc.), geographic location, or other such factors. Merchant system 130 may acquire this outside information from external servers within system environment 100, such as from financial service system 110 or user system 120, or may access previously gathered information stored in an internal memory, such as memory 132 and/or an associated database (not shown). Carrying forward the air conditioning example discussed above, merchant system 130 might determine through analysis of sensor data that out of thirty user systems 120 analyzed in a given geographic area prior to a heat wave, sensors indicate that thirteen of them are more than ten years old.

Merchant system 130 may generate and provide targeted marketing to one or more consumers based on the analyzed sensor data (Step 760). In some embodiments, the targeted marketing may comprise an incentive offer, such as a coupon, free item or service, or other discount. In other embodiments, the targeted marketing may comprise a reminder; for example, sensor data may indicate that it has been a year since a product maintained previously by merchant system 130 was serviced, and merchant system 130 may provide the user system 120 associated with the consumer a reminder to have the product serviced again. In still other embodiments, the targeted marketing may comprise advertising geared towards new customers. As a non-limiting example, to complete the air conditioning scenario described above, merchant system 130 may send a flyer by postal mail to the thirteen customers deemed to have older air conditioning systems, and the flyer may further contain an incentive offer for a discount off of cooling system service.

Other features and functionalities of the described embodiments are possible. For example, the processes of FIGS. 2-7 are not limited to the sequences described above. Variations of these sequences, such as the removal and/or the addition of other process steps may be implemented without departing from the spirit and scope of the disclosed embodiments.

Additionally, any financial institution that provides loan accounts to customers may employ systems, methods, and articles of manufacture consistent with certain principles related to the disclosed embodiments. In addition, any buyer or seller of an item in a private transaction may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

1-20. (canceled)

21. A system for assisting with maintenance of an asset, the system comprising:
a hardware sensor;
one or more memories storing instructions; and
one or more processors configured to execute the instructions to perform operations comprising:
identifying the asset;
configuring the sensor to interface with the processor;
determining information to acquire from the configured sensor, the determined information relating to types of data affecting operation of the asset, the sensor being further configured to provide feedback related to the determined information when a triggering event occurs;
acquiring the determined information from the configured sensor, the acquired information comprising:
information obtained when the sensor provides feedback, and
information obtained by a sensor data sampling process that monitors the data types;
determining if maintenance is required on the asset, based on at least on a comparison between the data types and predetermined criteria associated with the asset; and
based on the determination of whether maintenance is required, configuring the sensor such that maintenance may be performed remotely over a network.

22. The system of claim 21, wherein the sensor is configurable by any entity for access by one or more other entities.

23. The system of claim 22, wherein configuring the sensor comprises configuring the sensor by a third party.

24. The system of claim 21, wherein configuring the sensor comprises at least one of:
physically installing the sensor in association with the asset; or
configuring the sensor to communicate with a computer system across the network.

25. The system of claim 21,
wherein the information obtained by a sensor data sampling process comprises information based on at least one of a type of user system, a type of merchant system, or a type of asset; and
wherein the determined information comprises at least one of:
an error code indicating at least one of a past, a current, or a future problem with the asset;
maintenance history of the asset;
an occurrence of an event that triggers the sensor;
an operating status of the sensor;
a most recent time the asset was serviced;
an age of the asset; or
a number of hours the asset has been operated over a particular period of time.

26. The system of claim 21, wherein the sensor is further configured to transmit an error code indicating a type of required maintenance.

27. The system of claim 26, wherein the operations further comprise:
updating the determination of whether maintenance is required on the asset based on an error code indicating a indicating a type of required maintenance.

28. A method for assisting with maintenance of an asset, the method comprising:
identifying the asset;
configuring a hardware sensor to interface with a processor;
determining information to acquire from the configured sensor, the determined information relating to types of data affecting operation of the asset, the sensor being further configured to provide feedback related to the determined information when a triggering event occurs;
acquiring the determined information from the configured sensor, the acquired information comprising:
information obtained when the sensor provides feedback, and
information obtained by a sensor data sampling process that monitors the data types;
determining if maintenance is required on the asset, based on at least on a comparison between the data types and predetermined criteria associated with the asset; and
based on the determination of whether maintenance is required, configuring the sensor such that maintenance may be performed remotely over a network.

29. The method of claim 28, wherein the sensor is configurable by any entity for access by one or more other entities.

30. The method of claim 29, wherein configuring the sensor comprises configuring the sensor by a third party.

31. The method of claim 28, wherein configuring the sensor comprises at least one of physically installing the sensor in association with the asset or configuring the sensor to communicate with a computer system across the network.

32. The method of claim 28,
wherein the information obtained by a sensor data sampling process comprises information based on at least one of a type of user system, a type of merchant system, or a type of asset; and
wherein the determined information comprises at least one of:
an error code indicating at least one of a past, a current, or a future problem with the asset;
maintenance history of the asset;
an occurrence of an event that triggers the sensor;
an operating status of the sensor;
a most recent time the asset was serviced;
an age of the asset; or
a number of hours the asset has been operated over a particular period of time.

33. The method of claim 28, wherein the sensor is further configured to transmit an error code indicating a type of required maintenance.

34. The method of claim 33, further comprising:
updating the determination of whether maintenance is required on the asset based on an error code indicating a indicating a type of required maintenance.

35. A non-transitory computer-readable storage medium storing processor-readable instructions, which when executed by a processor, perform a method comprising:
identifying an asset;
configuring a hardware sensor to interface with a processor;
determining information to acquire from the configured sensor, the determined information relating to types of data affecting operation of the asset, the sensor being further configured to provide feedback related to the determined information when a triggering event occurs;
acquiring the determined information from the configured sensor, the acquired information comprising:
information obtained when the sensor provides feedback; and
information obtained by a sensor data sampling process that monitors the data types;
determining if maintenance is required on the asset, based on at least on a comparison between the data types and predetermined criteria associated with the asset; and
based on the determination of whether maintenance is required, configuring the sensor such that maintenance may be performed remotely over a network.

36. The non-transitory computer-readable storage medium of claim 35, wherein the sensor is configurable by any entity for access by one or more other entities.

37. The non-transitory computer-readable storage medium of claim 36, wherein configuring the sensor comprises configuring the sensor by a third party.

38. The non-transitory computer-readable storage medium of claim 35, wherein configuring the sensor comprises at least one of physically installing the sensor in association with the asset or configuring the sensor to communicate with a computer system across the network.

39. The non-transitory computer-readable storage medium of claim 35,
wherein the information obtained by a sensor data sampling process comprises information based on at least one of a type of user system, a type of merchant system, or a type of asset; and
wherein the determined information comprises at least one of:
an error code indicating at least one of a past, a current, or a future problem with the asset;
maintenance history of the asset;
an occurrence of an event that triggers the sensor;
an operating status of the sensor;
a most recent time the asset was serviced;
an age of the asset; or
a number of hours the asset has been operated over a particular period of time.

40. The non-transitory computer-readable storage medium of claim 35, wherein the sensor is further configured to transmit an error code indicating a type of required maintenance.
